(19) United States
(12) Patent Application Publication
(10) Pub. No.: US 2025/0316245 A1
(43) Pub. Date: Oct. 9, 2025

(54) OPTIMIZED WAVEFORM PROCESSING

(71) Applicant: RAKUTEN KOBO INC., Toronto (CA)

(72) Inventor: Donald WONG, Toronto (CA)

(73) Assignee: RAKUTEN KOBO INC., Toronto (CA)

(21) Appl. No.: 19/169,890

(22) Filed: Apr. 3, 2025

Related U.S. Application Data
(60) Provisional application No. 63/574,163, filed on Apr. 3, 2024.

(51) Int. Cl. G09G 3/34

(52) U.S. Cl. CPC G09G 3/34; G09G 2310/06; G09G 2320/0606; G09G 2320/0613

(57) ABSTRACT

A device may include a display including a rendering area. The device may include circuitry configured to obtain data associated with digital content including multiple digital content types. The circuitry may be configured to segment, based on the data, the rendering area into regions including digital content of different digital content types of the multiple digital content types. The circuitry may be configured to determine, based on the different digital content types, waveform modes for the regions. The circuitry may be configured to cause, based on the waveform modes for the regions, the digital content of the different digital content types to be rendered.

### CROSS-REFERENCE TO RELATED APPLICATION

This application claims the benefit of U.S. Provisional Application No. 63/574,163, filed Apr. 3, 2024, which is incorporated herein by reference in its entirety.

### BACKGROUND

An electronic device may be configured to visually present information, such as digital content, on a display for user interaction and consumption. For example, the electronic device may process and render text, images, and/or graphical elements for display.

### SUMMARY

Some implementations described herein relate to a device, comprising: a display including a rendering area; and circuitry configured to: obtain data associated with digital content including multiple digital content types; segment, based on the data, the rendering area into regions including digital content of different digital content types of the multiple digital content types; determine, based on the different digital content types, waveform modes for the regions; cause, based on the waveform modes for the regions, the digital content of the different digital content types to be rendered.

Some implementations described herein relate to a method, comprising: obtaining, by a device including a rendering area, data associated with digital content including multiple digital content types; segmenting, by the device and based on the data, the rendering area into regions including digital content of different digital content types of the multiple digital content types; determining, by the device and based on the different digital content types, waveform modes for the regions; and causing, by the device and based on the waveform modes for the regions, the digital content of the different digital content types to be rendered.

Some implementations described herein relate to a non-transitory computer-readable medium storing a set of instructions, the set of instructions comprising: one or more instructions that, when executed by one or more processors of a device including a rendering area, cause the device to: obtain data associated with digital content including multiple digital content types; segment the rendering area into regions including digital content of different digital content types of the multiple digital content types; determine based on the different digital content types, waveform modes for the regions; and cause, based on the waveform modes for the regions, the digital content of the different digital content types to be rendered.

### BRIEF DESCRIPTION OF THE DRAWINGS

FIGS. 1A-1D are diagrams of an example associated with optimized waveform processing.

FIG. 2 is a diagram of example components of a device associated with optimized waveform processing.

FIG. 3 is a flowchart of an example process associated with optimized waveform processing.

### DETAILED DESCRIPTION OF EXAMPLE EMBODIMENTS

The following detailed description of example implementations refers to the accompanying drawings. The same reference numbers in different drawings may identify the same or similar elements.

An electronic device may use waveform modes to control transitions related to a display that visually represents content, such as digital content. A waveform mode may refer to using signals (e.g., sequences of voltage signals) to change display states of the display. However, there are challenges associated with typical waveform modes.

For example, waveform modes that prioritize speed often result in reduced rendering quality while waveform modes that prioritize image fidelity often negatively affect rendering times. Additionally, typical waveform modes often require manual user input to adjust settings, forcing users to choose between rendering speed and image quality, which can be inconvenient and negatively impact an overall user experience.

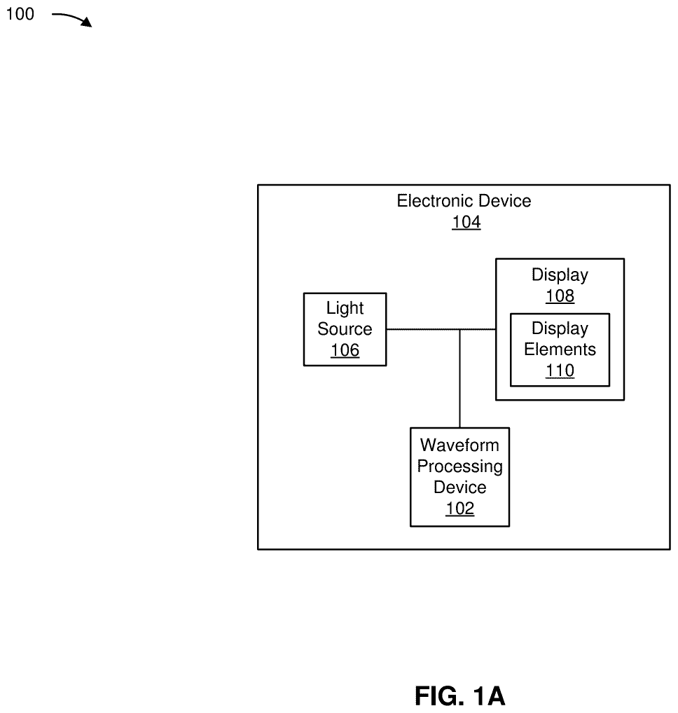

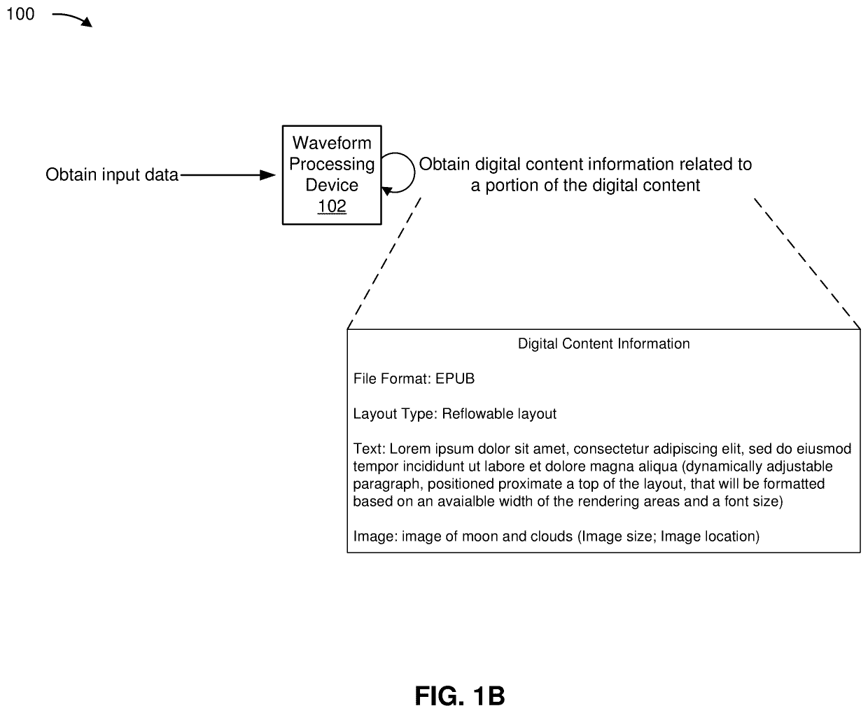

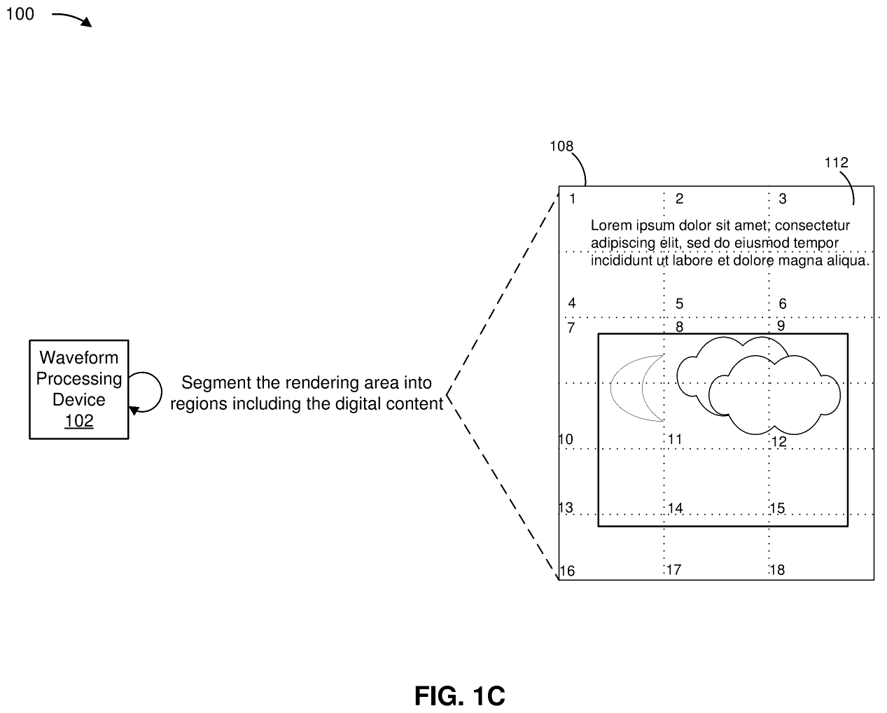

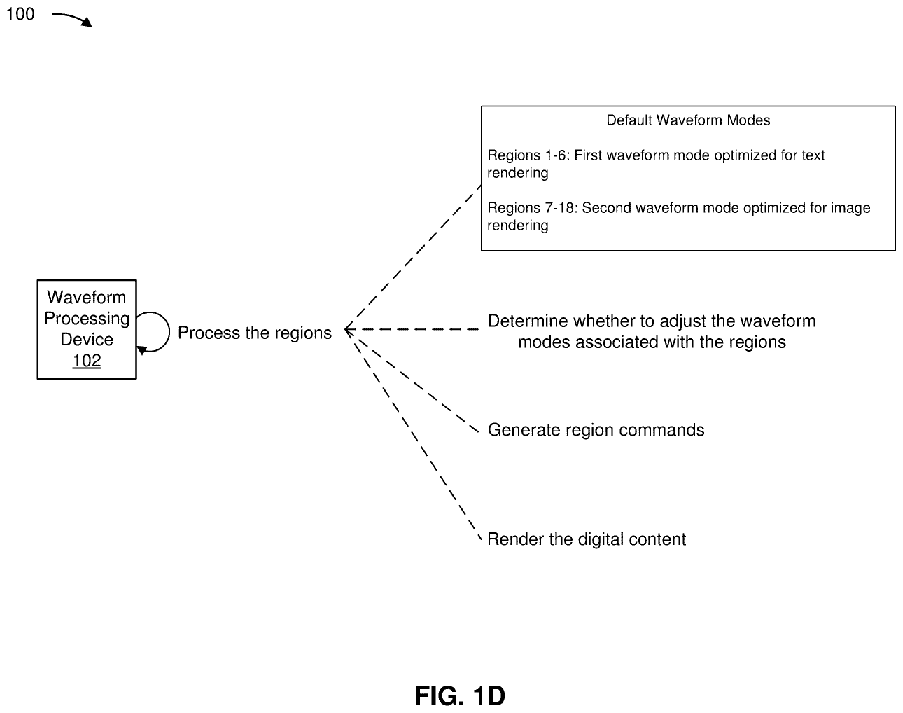

FIGS. 1A-1D are diagrams of an example 100 associated with optimized waveform processing. As shown in FIG. 1A, the example 100 includes a waveform processing device 102. In some implementations, the waveform processing device 102 may be configured to process content, such as digital content (e.g., text, images, and/or graphical elements, among other examples) associated with an electronic device.

Accordingly, and in some implementations, the waveform processing device 102 may be part of an electronic device (e.g., an electronic device 104, as shown in FIG. 1A, including a light source 106, a display 108 including display elements 110, and the waveform processing device 102). For example, the waveform processing device 102 may be implemented as circuitry within the electronic device 104.

Although the waveform processing device 102 is described as being part of the electronic device 104, in some implementations, the waveform processing device 102 may be separate from the electronic device 104. For example, the waveform processing device 102 may be implemented as a server device communicably coupled to the electronic device 104, among other examples.

In some implementations, the light source 106 may be a front light and the display may be a reflective display (e.g., a reflective color display). For example, the front light may be a color temperature adjustable front light, a red-green-blue (RGB) adjustable front light, a single-color white light-emitting diode (LED) front light, and/or a tunable multi-spectrum front light, among other examples. The front light may be configured to direct light toward the reflective display (e.g., the front light may be positioned to direct light through a light guide layer to illuminate the display without emitting light directly from the pixels). The front light may be configured to emit light toward the display 108, and the display elements 110 may be configured to reflect the light to visually present digital content.

In some implementations, the waveform processing device 102 may be configured to perform optimized waveform processing. For example, the waveform processing device 102 may be configured to use optimized waveform modes to manage display states of the display elements 110 (e.g., pixels, among other examples), as described in more detail elsewhere herein.

In some implementations, the waveform modes may be associated with characteristics that influence how they are applied to the display elements 110, such as voltage characteristics (e.g., magnitude, duration, and polarity of the voltage pulses, which control the transition behavior of the display), duration and timing characteristics (e.g., associated with a number of cycles associated with one or more waveform modes), temperature sensitivity characteristics (e.g., related to temperature-induced changes and/or effects), and/or power consumption characteristics (e.g., related to energy using during waveform mode execution), among other examples.

As shown in FIG. 1B, the waveform processing device 102 may be configured to obtain input data. In some implementations, the input data may include user input data, user preference data, and/or digital content data, among other examples.

In some implementations, the user input data may include interaction data (e.g., indicative of a type, a frequency, and/or an intensity of user interactions), navigation data (e.g., indicative of page numbers, scrolling positions, zoom factors, and/or menu selections), stylus input data (e.g., indicative of a stroke pressure, a movement speed, and/or a stylus angle related to interactions between a stylus and the electronic device 104), and/or command data (e.g., including signals corresponding to page-turn commands, refresh requests, and/or user interface (UI) selections), aging data (e.g., indicative of ghosting effects and/or or long-term use patterns), refresh request data (e.g., indicative of whether a full refresh or a partial refresh has been requested), and/or adaptive refresh data (e.g., indicative of metrics based on past user behavior, device usage patterns, and/or digital content types), among other examples.

In some implementations, the user preference data may include display mode preference data (e.g., indicative of whether light mode or dark mode is selected), font and text preference data (e.g., indicative of a preferred font type, font size, line spacing, and/or boldness level), brightness and front light preference data (e.g., indicative of a brightness level, whether adaptive brightness is enabled, and/or whether a front light or a back light is active), refresh rate preference data (e.g., indicative of a user-defined refresh frequency and/or preferred waveform modes related to interactions), power-saving preference data (e.g., indicative of whether low-power mode is enabled and/or whether refresh frequency should be reduced to minimize energy consumption), accessibility preference data (e.g., indicative of high-contrast mode, grayscale adjustments, text-to-speech settings, and/or other accessibility-related display settings), and/or gesture and navigation preference data (e.g., indicative of preferred navigation methods such as tap-based page turns versus swipe-based interactions), among other examples.

In some implementations, the digital content data may include digital content and digital content information. The digital content may include various digital content types. For example, the various digital content types may include text (e.g., corresponding to text-based content) and/or images (e.g., corresponding to image-based content), among other examples.

The digital content information may be associated with a format and/or a presentation of the digital content (e.g., the text and/or the images within the digital content). For example, the digital content information may specify a file format (e.g., an electronic publication (EPUB), a portable document format (PDF), a mobipocket (MOBI), and/or a comic book zip (CBZ) file format) and/or a layout type (e.g., a reflowable layout, a fixed layout, a hybrid layout, and/or a fluid layout), among other examples, which determine how the digital content is structured and displayed across different devices.

In some implementations, the digital content information may include details related to the presentation of images within the digital content. For example, the digital content information may indicate locations where images appear, sizes of the images (e.g., image dimensions), positioning of the images (e.g., coordinates on the page), and/or resolutions of the images (e.g., measured in dots per inch (DPI)), among other examples. Accordingly, the waveform processing device 102 may use the digital information content for formatting and/or displaying the digital content (e.g. the text and/or the images within the digital content), as described in more detail elsewhere herein.

As further shown in FIG. 1B, the waveform processing device 102 may be configured to obtain digital content information related to a portion of the digital content, which may include text and an image. The waveform processing device 102 may be configured to generate a representation (e.g., a bitmap representation) of the text and the image. The representation may indicate positions of the text and the image in a rendering area (e.g., shown as a rendering area 112 in FIG. 1C) of the display 108.

In some implementations, an alignment of the representation to the rendering area 112 may be determined by layout characteristics, display resolution, and/or scaling factors, among other examples. For example, in a fixed-layout format, the representation may directly map to the rendering area 112 (e.g., with a one-to-one correspondence between pixels representing the text and the image and the display elements 110. As another example, in a reflowable layout, the representation may be adjusted (e.g., dynamically adjusted) based on factors, such as font size, rendering area dimensions, and/or orientation information, among other examples.

In some implementations, the digital content information may indicate a file format (e.g., shown as a file format of EPUB in FIG. 1B), a layout type (e.g., shown as a reflowable layout in FIG. 1B), text and text information (e.g., shown as Lorem ipsum dolor sit amet, consectetur adipiscing elit, sed do eiusmod tempor incididunt ut labore et dolore magna aliqua (dynamically adjustable paragraph, positioned proximate a top of the layout, that will be formatted based on an available width of the rendering areas and a font size) in FIG. 1B), and/or image and image information (e.g., shown as image of moon and clouds (Image size; Image location) in FIG. 1B).

As shown in FIG. 1C, the waveform processing device 102 may segment the rendering area 112 into regions. In some implementations, the regions may be associated with shapes that allow tessellation of the rendering area 112. For example, the regions may be shaped as squares, rectangles, hexagons, and/or equilateral triangles, among other examples. Accordingly, and in some implementations, the regions may be nonoverlapping.

In some implementations, the regions may be associated with a digital content type. For example, each region may include a same digital content type (e.g. reach region may include text or one or more images). As shown in FIG. 1C, and for example, the rendering area 112 is segmented into 18 nonoverlapping regions with regions 1-6 including parts of the text and with regions 7-18 including parts of the image of the portion of the digital content.

As shown in FIG. 1D, the waveform processing device 102 may be configured to process the regions. In some implementations, the waveform processing device 102 may be configured to associate waveform modes with the regions based on one or more rules, constraints, parameters, conditions, and/or thresholds associated with the regions, the digital content included in the regions, and/or the digital content information related to the portion of the digital content.

For example, the waveform processing device 102 may be configured to assign waveform modes, optimized for text rendering, to regions including text. As another example, the waveform processing device 102 may be configured to assign waveform modes, optimized for image rendering, to regions including one or more images. As shown in FIG. 1D, and for example, the waveform processing device 102 may be configured to assign default waveform modes, optimized for text rendering, to regions 1-6 (e.g., based on regions 1-6 including parts of the text) and may be configured to assign default waveform modes, optimized for image rendering, to regions 7-18 (e.g., based on regions 7-18 including the parts of the image).

As another example, and if a size of an image included in a region satisfies a first size threshold (e.g., if the size of the image included in the region is smaller than the first size threshold), the waveform processing device 102 may be configured to refrain from assigning a waveform mode to the region. As shown in FIG. 1D, and for example, if a size of the parts of the image included in regions 16-18 satisfy the first size threshold, the waveform processing device 102 may be configured to refrain from assigning the waveform modes, optimized for image rendering, to regions 16-18.

As another example, and if images included in regions in proximity to one another, the waveform processing device 102 may be configured to combine the regions into a combined region and assign a waveform mode, optimized for image rendering, to the combined region. In other words, the digital content included in the combined region may be processed as a single image rather than being processed as multiple parts of an image. As an example, the waveform processing device 102 may be configured to combine regions 7-18 into a combined region and assign a waveform mode to the combined region rather than assigning waveform modes, optimized for image rendering, to regions 7-18 individually.

As another example, and if a number of images included in the regions satisfies an image number threshold, the waveform processing device 102 may be configured to assign a waveform mode, optimized for image rendering, to all regions. In other words, because the number of images included in the regions is greater than the image number threshold, the digital content corresponding to the representation may be processed as an image spanning an entirety of the rendering area 112.

As another example, and if a size of an image included in the portion of the digital content satisfies a second size threshold (e.g., if the size of the image included in the portion of the digital content is larger than the second size threshold), the waveform processing device 102 may be configured to assign a waveform mode, optimized for image rendering, to all regions. In other words, because the image is larger than the size threshold, the digital content corresponding to the representation may be processed as an image spanning an entirety of the rendering area 112.

As another example, and if a layout type of the representation is a fixed layout, the waveform processing device 102 may be configured to assign a waveform mode, optimized for image rendering, to all regions. In other words, because the layout type of the representation is a fixed layout, the digital content corresponding to the representation may be processed as an image spanning an entirety of the rendering area 112.

As further shown in FIG. 1D, the waveform processing device 102 may be configured to determine whether to adjust the waveform modes associated with the regions, as described in more detail elsewhere herein. In some implementations, the waveform processing device 102 may be configured to determine whether to adjust a waveform mode associated with a region to an adjusted (e.g., a different) waveform mode based on analyzing the user input data, the user preference data, and/or the representation.

For example, the waveform processing device 102 may be configured to adjust a waveform mode associated with a region to an adjusted waveform mode with a different latency. As an example, the waveform processing device 102 may be configured to adjust a waveform mode associated with a region to an adjusted waveform mode with a lower latency based on user input data indicative of scrolling activity (e.g., to apply lower latency transitions to the display elements 110 of the region).

As another example the waveform processing device 102 may be configured to adjust a waveform mode associated with a region to an adjusted waveform mode with a higher latency based on user preference data indicative of color rendering (to apply higher latency transitions to the display elements 110 to allow for improved vibrancy and contrast in the color rendering).

As another example, the waveform processing device 102 may be configured to adjust a waveform mode associated with a region to an adjusted waveform mode with inverted processing relative to the waveform mode based on user preference data indicative of a transition from a light mode setting to a dark mode setting (e.g., to optimize presentation of inverted colors while mitigating ghosting artifacts). As another example, the waveform processing device 102 may be configured to adjust a waveform mode associated with a region to an adjusted waveform mode with non-inverted processing based on user preference data indicative of a transition from a dark mode setting to a light mode setting (e.g., to optimize presentation of black text clarity on a white background). As another example, the waveform processing device 102 may be configured to adjust a waveform mode associated with a region to an adjusted waveform mode with a lower power consumption based on an area of the region (e.g., to use less power executing the waveform mode based on the area of the region satisfying an area threshold, among other examples). As another example, the waveform processing device 102 may be configured to adjust a waveform mode associated with a region to an adjusted waveform mode that was used in a latest cycle based on the representation indicating that the display element 110 is already in a correct state.

As further shown in FIG. 1D, the waveform processing device 102 may be configured to generate commands (e.g., region commands). In some implementations, the region commands may include information associated with implementing the waveform modes of the regions. For example, the information may include dimensions of the regions (e.g., an area of the regions, among other examples), a waveform mode to be applied to the regions (e.g., waveform modes or adjusted waveform modes assigned to the regions, among other examples), and/or any other suitable information (e.g., dithering, resolution, grayscale, color depth, refresh rate, contrast ratio, latency, refresh cycle length, temperature sensitivity, power consumption, rendering area size, ghosting, artifacts, display orientation, and/or layout information, among other examples).

As further shown in FIG. 1D, the waveform processing device 102 may be configured to render the digital content. For example, the waveform processing device 102 may be configured to render (e.g., simultaneously render) the parts of the text included in regions 1-6 (e.g., based on applying the waveform modes or adjusted waveform modes assigned to regions 1-6) and the parts of the image included in regions 7-18 (e.g., based on applying the waveform modes or adjusted waveform modes assigned to regions 7-18). In this way, the waveform processing device 102 may be configured to efficiently render (e.g., simultaneously render) the digital content included in the regions (e.g., because the regions are nonoverlapping and because the waveform modes assigned to the regions are compatible with one another), as described in more detail elsewhere herein.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

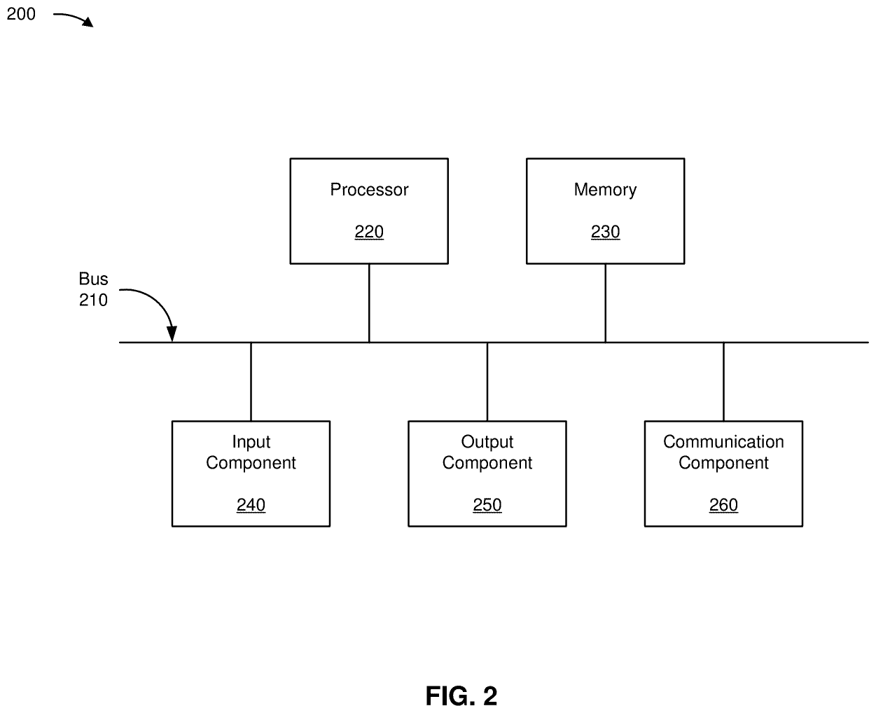

FIG. 2 is a diagram of example components of a device 200 associated with optimized waveform processing. The device 200 may correspond to the waveform processing device 102, the electronic device 104, the light source 106, and/or the display 108. In some implementations, the waveform processing device 102, the electronic device 104, the light source 106, and/or the display 108 may include one or more of the devices 200 and/or one or more components of the device 200. As shown in FIG. 2, the device 200 may include a bus 210, a processor 220, a memory 230, an input component 240, an output component 250, and/or a communication component 260.

The bus 210 may include one or more components that enable wired and/or wireless communication among the components of the device 200. The bus 210 may couple together two or more components of FIG. 2, such as via operative coupling, communicative coupling, electronic coupling, and/or electric coupling. For example, the bus 210 may include an electrical connection (e.g., a wire, a trace, and/or a lead) and/or a wireless bus. The processor 220 may include a central processing unit, a graphics processing unit, a microprocessor, a controller, a microcontroller, a digital signal processor, a field-programmable gate array, an application-specific integrated circuit, and/or another type of processing component. The processor 220 may be implemented in hardware, software, and/or a combination of hardware and software. In some implementations, the processor 220 may include one or more processors capable of being programmed to perform one or more operations or processes described elsewhere herein.

The memory 230 may include volatile and/or nonvolatile memory. For example, the memory 230 may include random access memory (RAM), read only memory (ROM), a hard disk drive, and/or another type of memory (e.g., a flash memory, a magnetic memory, and/or an optical memory). The memory 230 may include internal memory (e.g., RAM, ROM, or a hard disk drive) and/or removable memory (e.g., removable via a universal serial bus connection). The memory 230 may be a non-transitory computer-readable medium. The memory 230 may store information, one or more instructions, and/or software (e.g., one or more software applications) related to the operation of the device 200. In some implementations, the memory 230 may include one or more memories that are coupled (e.g., communicatively coupled) to one or more processors, such as via the bus 210. Communicative coupling between the processor 220 and the memory 230 may enable the processor 220 to read and/or process information stored in the memory 230 and/or to store information in the memory 230.

The input component 240 may enable the device 200 to receive input, such as user

input and/or sensed input. For example, the input component 240 may include a touch screen, a keyboard, a keypad, a mouse, a button, a microphone, a switch, a sensor, a global positioning system sensor, an accelerometer, a gyroscope, and/or an actuator. The output component 250 may enable the device 200 to provide output, such as via a display, a speaker, and/or a light-emitting diode. The communication component 260 may enable the device 200 to communicate with other devices via a wired connection and/or a wireless connection. For example, the communication component 260 may include a receiver, a transmitter, a transceiver, a modem, a network interface card, and/or an antenna.

The device 200 may perform one or more operations or processes described herein. For example, a non-transitory computer-readable medium (e.g., memory 230) may store a set of instructions (e.g., one or more instructions or code) for execution by the processor 220. The processor 220 may execute the set of instructions to perform one or more operations or processes described herein. In some implementations, execution of the set of instructions, by one or more processors, causes the one or more processors and/or the device 200 to perform one or more operations or processes described herein. In some implementations, hardwired circuitry may be used instead of or in combination with the instructions to perform one or more operations or processes described herein. Additionally, or alternatively, the processor 220 may be configured to perform one or more operations or processes described herein. Thus, implementations described herein are not limited to any specific combination of hardware circuitry and software.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

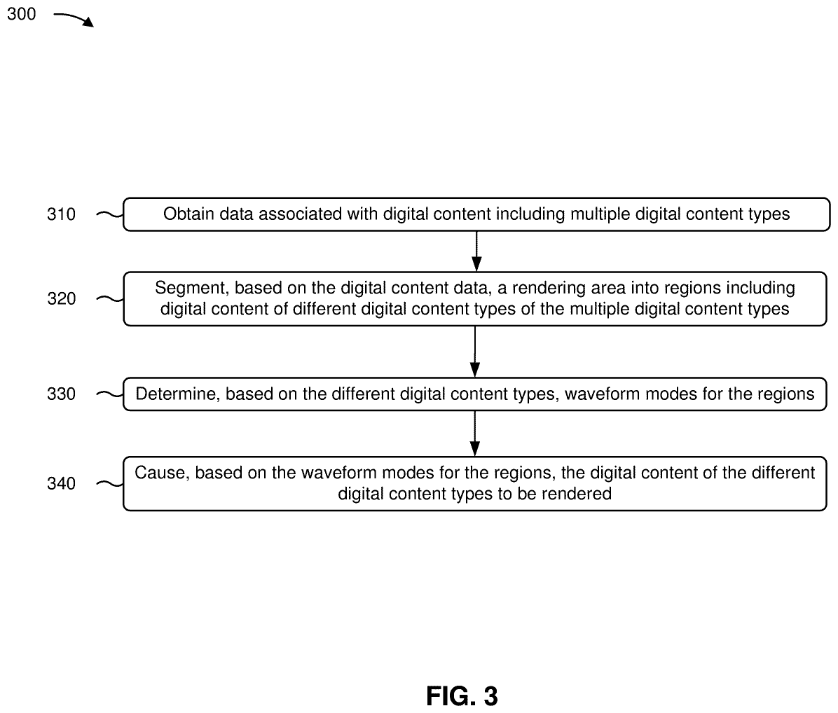

FIG. 3 is a flowchart of an example process 300 associated with optimized waveform processing. In some implementations, one or more process blocks of FIG. 3 may be performed by a waveform processing device (e.g., the waveform processing device 102). In some implementations, one or more process blocks of FIG. 3 may be performed by another device or a group of devices separate from or including the waveform processing device, such as an electronic device (e.g., the electronic device 104) and/or one or more components of an electronic device (e.g., the light source 106, the display 108, and/or the display elements 110 of the electronic device 104). Additionally, or alternatively, one or more process blocks of FIG. 3 may be performed by one or more components of the device 200, such as the processor 220, the memory 230, the input component 240, the output component 250, and/or the communication component 260.

As shown in FIG. 3, the process 300 may include obtaining data associated with digital content including multiple digital content types (block 310). For example, the waveform processing device may obtain data associated with digital content including multiple digital content types, as described in more detail elsewhere herein.

As further shown in FIG. 3, the process 300 may include segmenting, based on the digital content data, a rendering area into regions including digital content of different digital content types of the multiple digital content types (block 320). For example, the waveform processing device may segment, based on the digital content data, a rendering area into regions including digital content of different digital content types of the multiple digital content types, as described in more detail elsewhere herein.

As further shown in FIG. 3, the process 300 may include determining, based on the different digital content types, waveform modes for the regions (block 330). For example, the waveform processing device may determine, based on the different digital content types, waveform modes for the regions, as described in more detail elsewhere herein.

As further shown in FIG. 3, the process 300 may include causing, based on the waveform modes for the regions, the digital content of the different digital content types to be rendered (block 340). For example, the waveform processing device may be configured to cause, based on the waveform modes for the regions, the digital content of the different digital content types to be rendered, as described in more detail elsewhere herein.

In some implementations, the regions are nonoverlapping. In some implementations, the regions may include first regions including text and second regions including one or more images. In some implementations, the digital content, of the different digital content types, may be rendered simultaneously. In some implementations, the data may include at least one of user input data and user preference data, and the process 300 may include adjusting, based on the at least one of the user input data or the user preference data, at least one waveform mode for at least one region to at least one adjusted waveform mode for the at least one region. In some implementations, the process 300 may include generating, based on the waveform modes for the regions, commands, and applying the commands to render the digital content of the different digital content types. In some implementations, the regions may be associated with initial waveform modes based on the different digital content types and at least one waveform mode may be different from at least one initial waveform mode.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

As used herein, the term “component” is intended to be broadly construed as hardware, software, and/or a combination of hardware and software. It will be apparent that systems and/or methods described herein may be implemented in different forms of hardware, software, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Additionally, the functionality of the elements described herein may be implemented using circuitry or processing circuitry, including general-purpose processors, special-purpose processors, ICs, ASICs, conventional circuitry, or combinations thereof, configured or programmed to perform the disclosed functionality. A processor is a type of processing circuitry, as it includes transistors and other physical circuit components. A processor may execute instructions stored in a memory, thereby operating as a programmed processor. In this disclosure, the terms “circuitry,” “units,” or “means” refer to hardware that performs, or is programmed to perform, the described functionality. Such hardware may include any disclosed hardware or other known hardware that is configured or programmed to execute the described functions. When the hardware includes a processor, which is a type of circuitry, the circuitry, means, or units refer to a combination of hardware and software, where the software configures the hardware and/or processor to perform the specified functions.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of”' a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A device, comprising:
a display including a rendering area; and
circuitry configured to:
obtain data associated with digital content including multiple digital content types;
segment, based on the data, the rendering area into regions including digital content of different digital content types of the multiple digital content types;
determine, based on the different digital content types, waveform modes for the regions;
cause, based on the waveform modes for the regions, the digital content of the different digital content types to be rendered.

2. The device of claim 1, wherein the regions are nonoverlapping.

3. The device of claim 1, wherein the regions include first regions including text and second regions including one or more images.

4. The device of claim 1, wherein the digital content, of the different digital content types, is rendered simultaneously.

5. The device of claim 1, wherein the data includes at least one of user input data and user preference data, and
wherein the circuitry is further configured to:
adjust, based on the at least one of the user input data or the user preference data, at least one waveform mode for at least one region to at least one adjusted waveform mode for the at least one region.

6. The device of claim 1, wherein the circuitry, to cause, based on the waveform modes for the regions, the digital content of the different digital content types to be rendered, is configured to:
generate, based on the waveform modes for the regions, commands; and
apply the commands to render the digital content of the different digital content types.

7. The device of claim 1, wherein the regions are associated with initial waveform modes based on the different digital content types, and
wherein at least one waveform mode is different from at least one initial waveform mode.

8. A method, comprising:
obtaining, by a device including a rendering area, data associated with digital content including multiple digital content types;
segmenting, by the device and based on the data, the rendering area into regions including digital content of different digital content types of the multiple digital content types;
determining, by the device and based on the different digital content types, waveform modes for the regions; and
causing, by the device and based on the waveform modes for the regions, the digital content of the different digital content types to be rendered.

9. The method of claim 8, wherein the regions are nonoverlapping.

10. The method of claim 8, wherein the regions include first regions including text and second regions including one or more images.

11. The method of claim 8, wherein the digital content, of the different digital content types, is rendered simultaneously.

12. The method of claim 8, wherein the data includes at least one of user input data and user preference data, and
wherein the method further comprises:
adjusting, by the device and based on the at least one of the user input data or the user preference data, at least one waveform mode for at least one region to at least one adjusted waveform mode for the at least one region.

13. The method of claim 8, wherein causing, by the device and based on the waveform modes for the regions, the digital content of the different digital content types to be rendered, comprises:
generating, by the device and based on the waveform modes for the regions, commands; and
applying, by the device, the commands to render the digital content of the different digital content types.

14. The method of claim 8, wherein the regions are associated with initial waveform modes based on the different digital content types, and
wherein at least one waveform mode is different from at least one initial waveform mode.

15. A non-transitory computer-readable medium storing a set of instructions, the set of instructions comprising:
one or more instructions that, when executed by one or more processors of a device including a rendering area, cause the device to:
obtain data associated with digital content including multiple digital content types;
segment the rendering area into regions including digital content of different digital content types of the multiple digital content types;
determine based on the different digital content types, waveform modes for the regions; and
cause, based on the waveform modes for the regions, the digital content of the different digital content types to be rendered.

16. The non-transitory computer-readable medium of claim 15, wherein the regions are nonoverlapping.

17. The non-transitory computer-readable medium of claim 15, wherein the regions include first regions including text and second regions including one or more images.

18. The non-transitory computer-readable medium of claim 15, wherein the regions include first regions including text and second regions including one or more images.

19. The non-transitory computer-readable medium of claim 15, wherein the digital content, of the different digital content types, is rendered simultaneously.

20. The non-transitory computer-readable medium of claim 15, wherein the data includes at least one of user input data and user preference data, and
wherein the one or more instructions that, when executed by the one or more processors of the device, cause the device to:
adjust, based on the at least one of the user input data or the user preference data, at least one waveform mode for at least one region to at least one adjusted waveform mode for the at least one region.
